(19) United States
(12) Patent Application Publication
(10) Pub. No.: US 2026/0167337 A1
(43) Pub. Date: Jun. 18, 2026

(54) METHOD AND SYSTEM FOR DETECTING ICE ON AN AIRCRAFT

(71) Applicant: AIRBUS OPERATIONS SAS, Toulouse (FR)

(72) Inventors: Philippe GOUPIL, Toulouse (FR); Ouassim BARA, Toulouse (FR); Nils CAHINGT, Toulouse (FR)

(73) Assignee: AIRBUS OPERATIONS SAS, Toulouse (FR)

(21) Appl. No.: 19/418,593

(22) Filed: Dec. 12, 2025

(30) Foreign Application Priority Data
Dec. 17, 2024 (FR) 2414313

(51) Int. Cl. B64D 15/20; B64F 5/60; G07C 5/02

(52) U.S. Cl. CPC B64D 15/20; B64F 5/60; G07C 5/02

(57) ABSTRACT

A method for detecting the presence of ice on an aircraft, including: obtaining, in real time, measurements (provided by sensors) of a set of flight parameters comprising a slope, an incidence, a Mach number, a rotational speed of a low-pressure propulsion engine assembly of the aircraft, a fuel flow, a mass of the aircraft, a position of a trimmable horizontal stabilizer, a static temperature and a static pressure; injecting the obtained measurements into an artificial-intelligence model, trained and configured to calculate a presence of ice indicator based on measurements of the set of flight parameters; and providing the presence of ice indicator calculated by the model. This novel indirect method exhibits good performance because it is based on an artificial-intelligence model using a large number of flight parameters.

### TECHNICAL FIELD

The present invention relates to a method and system for detecting ice on an aircraft. It applies in particular to the automatic real-time detection of icing of an aircraft, in particular of the accretion of ice on the wings of the aircraft.

### PRIOR ART

Ice formation on an aircraft, in particular on its aerofoil, may significantly affect flight quality and performance, to the point of disrupting the control of the aircraft. Indeed, an accumulation (or accretion) of ice on the surfaces of the aircraft (in particular on the wings) may lead to a significant increase in the weight of the aircraft, a loss of lift, problems with the actuation of control surfaces, defects in terms of communication and functioning of the antennas, measurement errors made by the anemometric probes and losses of engine thrust, these various malfunctions being able to disrupt the control of the aircraft.

To overcome these malfunctions, aircraft authorized to fly in icing conditions are equipped with protection systems (also called anti-ice systems), in particular heating systems, integrated into the elements to be protected (aerofoil, probes, engine air intakes, etc.), preventing the formation or accumulation of ice. These protection systems are generally activated based on the pilot's judgement after the pilot has visually identified the presence of icing conditions. Since this identification is necessarily imperfect, one or more detection systems are generally used to help the pilot make their judgement.

Thus, conventionally, there are three known types of method that may be implemented by these detection systems to detect the presence of ice on an aircraft:
direct methods, based on the addition of specific sensors to the aerofoil and fuselage of the aircraft. Specific sensors are understood to mean sensors the measurements of which are intended exclusively to detect the presence of ice;
indirect methods, based on the use of non-specific sensors, which are already present on board to estimate the dynamics or performance of the aircraft. These are estimation methods (using for example a Kalman filter) for estimating a specific quantity in real time, to be compared with a tabulated reference value to verify the presence or absence of ice; and
atmospheric methods, based on the use of a radar and/or dedicated camera to classify clouds and calculate the probability of these causing ice formation.

One shared drawback of direct and atmospheric methods is that they require the addition of various sensors directly to the aircraft, this involving drilling the aerofoil and fuselage, providing mechanical reinforcements close to the hole, deploying electrical wiring and installing additional acquisition systems in electrical cabinets. The sensors also constitute an additional cost and an additional weight. In addition, the sensors often protrude from the skin of the aerofoil and fuselage and consequently cause induced drag, thereby impacting the performance of the aircraft.

One advantage of indirect methods is that they do not require the addition of various sensors directly to the aerofoil and fuselage of the aircraft. Known indirect methods exhibit performance that is beneficial but that it would be desirable to improve. For example, even the best-performing known indirect methods are highly sensitive to turbulence and sensor biases.

There is therefore a need to provide an indirect method that exhibits better performance than known indirect methods for detecting, automatically and in real time, the presence of ice on an aircraft, in particular on the wings.

### SUMMARY OF THE INVENTION

What is proposed is a method for detecting the presence of ice on an aircraft, the method being implemented by a detection system comprising electronic circuitry, the method comprising:
obtaining, in real time, measurements of a set of flight parameters of the aircraft, the measurements being provided by sensors present in the aircraft, the set of flight parameters comprising a batch of nine flight parameters comprising: a slope, denoted γair; an incidence, denoted α; a Mach number, denoted M; a rotational speed of a low-pressure propulsion engine assembly of the aircraft, denoted N1; a fuel flow, denoted F_flow; a mass of the aircraft, denoted m; a position of a trimmable horizontal stabilizer, denoted POSTHS; a static temperature, denoted Ts; and a static pressure, denoted Ps;
injecting the obtained measurements into an artificial-intelligence machine learning-based model, trained and configured to calculate an indicator of the presence of ice on the aircraft based on measurements of the set of flight parameters of the aircraft; and
providing the presence of ice indicator calculated by the machine learning-based model;
   the nine flight parameters of said batch being chosen for their presence in a first equation expressing an ice-induced drag, denoted ΔD_{icing}, and written:

$$Δ {D}_{i c i n g} = f 1 ( N 1 , F\_flow , M , {P}_{s} ) * cos ( α ) - m ( g * sin ( γ air ) + {d}_{x} ( f ( M , {T}_{s} ) ) / dt ) - ( 0. 5 * 1.4 * {M}^{2} * {P}_{s} ) * S * f 2 ( α , M , {P}_{s} , Conf , POSTHS )$$

said first equation deriving from a second equation expressing a longitudinal equilibrium of the aircraft and being written:

$$T * cos ( α ) - D - W * sin ( γ air ) = {a}_{{x}_{w}} * m$$

where:
T is a thrust of the aircraft, with: T=f1(N1, F_flow, M, Pₛ), where f1 is an actual thrust generated by the aircraft,
D is a drag of the aircraft, with: D=q*S*Cₓ+ΔD_{icing}, where S is a reference surface, Cₓ is a drag coefficient, with Cₓ=f2(α, M, Pₛ, Conf, POSTHS), where f2 is an actual drag, excluding that induced by ice, Conf is a configuration of the aircraft, and q is a dynamic pressure, with: q=0.5*1.4*M²*Pₛ,
W is a weight of the aircraft, with: W=m*g, where g is a gravitational acceleration,
and aₓ_{_{w}} is an acceleration of the aircraft, with: aₓ_{_{w}}=dₓV/dt=dₓ(f(M,Tₛ))/dt, where
f expresses a speed V of the aircraft as a function of M and Tₛ.

The proposed solution is thus a novel indirect method for detecting ice on an aircraft. It makes it possible to detect, automatically and in real time, the presence of ice on an aircraft, in particular on the wings. It exhibits better performance than known indirect methods because it is based on an artificial-intelligence machine learning-based model using a large number of flight parameters of the aircraft.

According to one particular embodiment, the set of flight parameters of the aircraft furthermore comprises at least one information redundancy parameter belonging to the group comprising: a true speed, denoted Vc; and a total pressure, denoted Pt.

According to one particular embodiment, the set of flight parameters of the aircraft furthermore comprises at least one context parameter belonging to the group comprising: a roll angle, denoted φ; a pitch angle, denoted θ; a yaw angle, denoted Ψ; a roll rate, denoted p1; a pitch rate, denoted q1; a yaw rate, denoted r1; a slip angle, denoted β; a pressure altitude, denoted Zp; a vertical speed, denoted Vz; and centring information, denoted CG.

According to one particular embodiment, the machine learning-based model is a deep neural network.

According to one particular embodiment, the deep neural network is a convolutional neural network comprising at least one convolutional layer and at least one subsampling layer.

What is also proposed is a computer program product, comprising instructions that cause a processor to carry out the abovementioned method according to any one of its embodiments when said instructions are executed by the processor.

What is also proposed is a storage medium storing such instructions.

What is also proposed is a system for detecting the presence of ice on an aircraft, the system comprising electronic circuitry configured to implement the following:
obtaining, in real time, measurements of a set of flight parameters of the aircraft, the measurements being provided by sensors present in the aircraft, the set of flight parameters comprising a batch of nine flight parameters comprising: a slope, denoted γair; an incidence, denoted α; a Mach number, denoted M; a rotational speed of a low-pressure propulsion engine assembly of the aircraft, denoted N1; a fuel flow, denoted F_flow; a mass of the aircraft, denoted m; a position of a trimmable horizontal stabilizer, denoted POSTHS; a static temperature, denoted Tₛ; and a static pressure, denoted Pₛ;
injecting the obtained measurements into an artificial-intelligence machine learning-based model, trained and configured to calculate an indicator of the presence of ice on the aircraft based on measurements of the set of flight parameters of the aircraft; and
providing the presence of ice indicator calculated by the machine learning-based model;
   the nine flight parameters of said batch being chosen for their presence in a first equation expressing an ice-induced drag, denoted ΔD_{icing}, and written:

$$Δ {D}_{i c i n g} = f 1 ( N 1 , F\_flow , M , {P}_{s} ) * cos ( α ) - m ( g * sin ( γ air ) + {d}_{x} ( f ( M , {T}_{s} ) ) / dt ) - ( 0. 5 * 1.4 * {M}^{2} * {P}_{s} ) * S * f 2 ( α , M , {P}_{s} , Conf , POSTHS )$$

said first equation deriving from a second equation expressing a longitudinal equilibrium of the aircraft and being written:

$$T * cos ( α ) - D - W * sin ( γ air ) = {a}_{{x}_{w}} * m$$

where:
T is a thrust of the aircraft, with: T=f1(N1, F_flow, M, Pₛ), where f1 is an actual thrust generated by the aircraft,
D is a drag of the aircraft, with: D=q*S*Cₓ+ΔD_{icing}, where S is a reference surface,
Cₓ is a drag coefficient, with Cₓ=f2(α, M, Pₛ, Conf, POSTHS), where f2 is an actual drag, excluding that induced by ice, Conf is a configuration of the aircraft, and q is a dynamic pressure, with: q=0.5*1.4*M²*Pₛ,
W is a weight of the aircraft, with: W=m*g, where g is a gravitational acceleration, and aₓ_{_{w}} is an acceleration of the aircraft, with: aₓ_{_{w}}=dₓV/dt=dₓ(f(M, Tₛ))/dt, where f expresses a speed V of the aircraft as a function of M and Tₛ.

What is also proposed is an aircraft comprising a system for detecting the presence of ice as mentioned above.

### BRIEF DESCRIPTION OF THE DRAWINGS

The abovementioned features of the invention, along with others, will become more clearly apparent upon reading the following description of at least one exemplary embodiment, said description being given with reference to the appended drawings, in which:

FIG. 1 schematically illustrates a side view of an aircraft equipped with a system for detecting the presence of ice;

FIG. 2 schematically illustrates one example of an algorithm for detecting the presence of ice, in one embodiment;

FIG. 3 schematically illustrates a set of forces exerted on the aircraft;

FIG. 4 schematically illustrates the model used by the system for detecting the presence of ice from FIG. 1, in one embodiment; and

FIG. 5 schematically illustrates an exemplary hardware architecture of the system for detecting the presence of ice from FIG. 1.

### DETAILED DESCRIPTION OF EMBODIMENTS

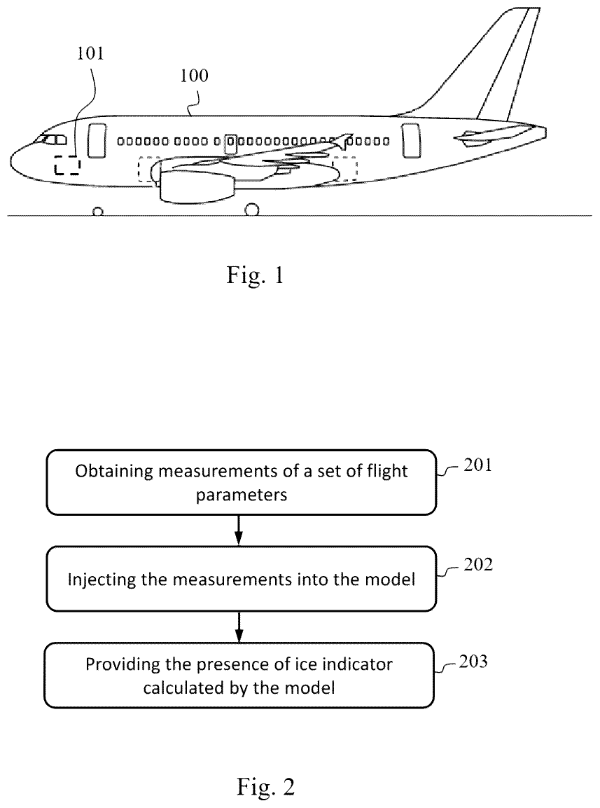

FIG. 1 schematically illustrates a side view of an aircraft 100. The aircraft 100 comprises a system 101 for detecting the presence of ice on the aircraft. The system 101 is implemented in the form of electronic circuitry, and is typically integrated into avionics of the aircraft. The system 101 is for example hosted in a flight control computer on board the aircraft (for example a flight control and guidance system, FCGS).

In this case, the method for detecting the presence of ice, which is carried out by the system 101, is therefore carried out entirely on board the aircraft. As detailed below, this method uses, in the production phase (also called the “use phase”), a machine learning-based model to calculate a presence of ice indicator. This model is estimated beforehand in a learning phase (also called a “training phase”).

In one variant (not illustrated), the system for detecting the presence of ice comprises a first part, on board the aircraft, and a second part, installed on the ground. For example, the on-board first part receives the measurements of the set of flight parameters of the aircraft, and transmits these measurements to the second part on the ground; the second part on the ground injects these measurements into the model and transmits the presence of ice indicator calculated by the model to the aircraft.

In the embodiment of FIG. 1, as in the abovementioned variant, the presence of ice indicator calculated by the model may be displayed on a screen in the cockpit of the aircraft, and possibly generate an alarm (that is to say trigger an alert). The pilot of the aircraft then has the option to activate the ice protection systems. As an alternative, the presence of ice indicator automatically activates the ice protection systems.

The system 101 implements a method (algorithm) for detecting the presence of ice. This method is illustrated schematically in FIG. 2, in one particular embodiment.

In a step 201, the system 101 obtains, in real time, measurements of a set of flight parameters of the aircraft. The measurements are provided by sensors present in the aircraft. The set of flight parameters comprises: a slope, denoted γair (in °); an incidence, denoted α (in °); a Mach number, denoted M (unitless); a rotational speed of a low-pressure propulsion engine assembly of the aircraft, denoted N1 (in %); a fuel flow, denoted F_flow (in kg/s); a mass of the aircraft, denoted m (in kg); a position of a trimmable horizontal stabilizer (THS), denoted POSTHS (in °); a static temperature, denoted Ts (in K); and a static pressure, denoted Ps (in Pa).

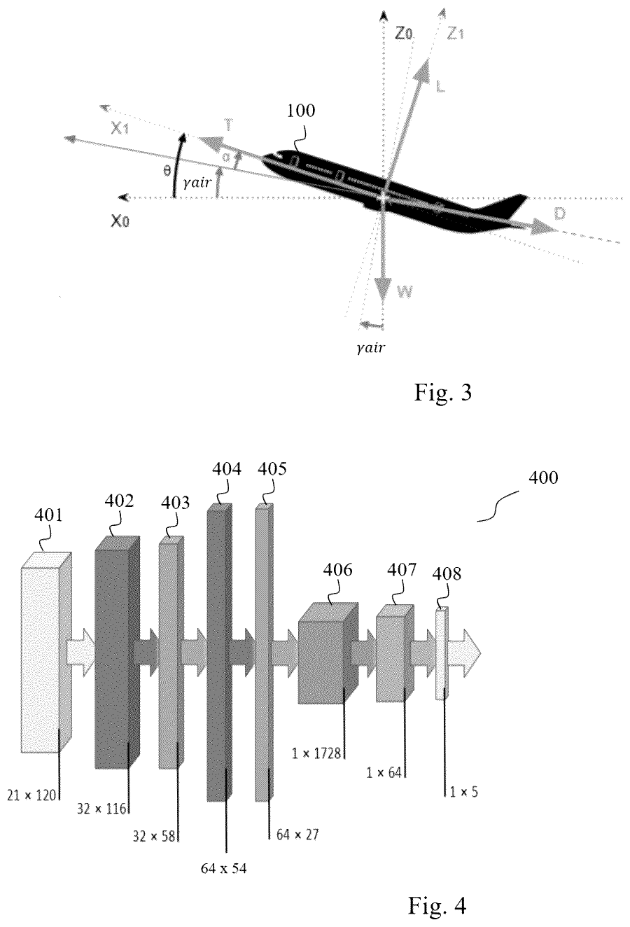

An explanation will be found below, with reference to FIG. 3, regarding the choice of this set of flight parameters of the aircraft.

In a first variant, the set of flight parameters of the aircraft furthermore comprises at least one information redundancy parameter belonging to the group comprising: a true speed, denoted Vc (in ft/s); and a total pressure, denoted Pt (in Pa).

In a second variant, the set of flight parameters of the aircraft furthermore comprises at least one context parameter belonging to the group comprising: a roll angle, denoted φ (in °); a pitch angle, denoted θ (in °); a yaw angle, denoted Ψ (in °); a roll rate, denoted p1 (in °/s); a pitch rate, denoted q1 (in °/s); a yaw rate, denoted r1 (in °/s); a slip angle, denoted β (in °); a pressure altitude, denoted Zp (in ft); a vertical speed, denoted Vz (in ft/s); and centring information, denoted CG (in %).

In a third variant, the set of flight parameters of the aircraft furthermore comprises both at least one of the information redundancy parameters from the first variant and at least one of the context parameters from the second variant.

In one particular case of this third variant, the set of flight parameters of the aircraft furthermore comprises both all the information redundancy parameters from the first variant and all the context parameters from the second variant. The set of flight parameters then comprises N_{P}=21 flight parameters.

In a step 202, the system 101 injects the obtained measurements into an artificial-intelligence machine learning-based model. This model is trained and configured to calculate an indicator of the presence of ice on the aircraft based on measurements of the set of flight parameters of the aircraft.

The artificial-intelligence model is chosen for example from:
a neural network
a Bayesian network; and
deep learning.

In one particular implementation, the model is a deep neural network that carries out deep learning. In one particular embodiment, the deep neural network is a convolutional neural network (CNN) comprising at least one convolutional layer and at least one subsampling layer (also called a pooling layer).

The general principle is as follows: when an aircraft equipped with standard sensors (pressure altimeters, Mach sensors, temperature sensors, engine rotational speed N1 sensors, etc.) passes through a cloud that triggers ice formation on the aerofoil, the newly created ice will influence the performance of the aircraft (add extra drag, change lift if the incidence is large enough). The model used in step 202 is capable of identifying this change in the current state of the aircraft (reflected by the temporal evolution of the set of flight parameters observed in real time) and of estimating the associated level of ice. It therefore warns the pilot that ice is forming on the aerofoil, and the pilot may choose whether or not to engage the anti-ice system if a de-icing threshold is reached.

In a step 203, the system 101 provides the presence of ice indicator calculated by the machine learning-based model.

The proposed solution thus consists of an artificial intelligence (AI) approach using a machine learning-based model that makes it possible to detect ice in efficient and robust fashion, in real time, possibly specifically for certain flight phases (for example the cruise phase or the final approach), and to do so using measurements already present on board the aircraft (no need to add new sensors or specific equipment). The proposed solution makes it possible, in real time, to guarantee detection of a given level of ice accretion on the wings.

Such an AI algorithm may be based on a supervised learning phase, made possible by actual flight data recorded on aircraft (aircraft belonging to an airline and/or test aircraft with artificial ice shapes), possibly supplemented by simulated flight data obtained with simulators.

The proposed solution may easily be adapted to an aircraft model and/or aircraft configuration. To achieve this, it is sufficient to train the algorithm on data associated with the desired aircraft model, by adding configuration information in addition to the abovementioned flight parameters. Likewise, it is just as easy to adapt the developed method to a particular flight phase if there are enough training data associated with this flight phase.

Usually, the detection of ice or the absence of ice is characterized as a binary classification problem (0: no ice; 1: ice present). However, it is also sought to characterize multiple intermediate levels of ice (multi-class classification). For example, a distinction is drawn between five classes of ice, each defined by a particular value of an accretion level K ice (which constitutes the presence of ice indicator discussed above) of between 0 and 1:
Kice=0: no ice on the aerofoil;
Kice=0.25: slight accretion of ice on the aerofoil;
Kice=0.5: medium accretion of ice on the aerofoil;
Kice=0.75: significant accretion of ice on the aerofoil; and
Kice=1: aerofoil completely iced.

Depending on the class of ice detected, and by comparison with a predetermined activation threshold (also called the “de-icing threshold”), it is possible to issue an alert to the pilot and/or to activate the protection system (anti-ice systems) at the appropriate time in order to optimize the energy performance of the aircraft (compromise between loss of performance due to drag caused by ice and loss of performance caused by the anti-ice system).

FIG. 3 schematically illustrates a set of forces exerted on the aircraft 100 and used to explain the choice of the set of flight parameters used by the (machine learning-based) model to calculate the presence of ice indicator.

The forces exerted on the aircraft 100 are: thrust T, drag D, weight W and lift L.

The flight parameters used by the model have been chosen based on the flight dynamics of the aircraft. In fact, under normal flight conditions (with an incidence below αₚᵣₒₜ, the maximum incidence defined by the flight controls), ice acts exclusively on the longitudinal equilibrium of the aircraft, via the addition of drag. The longitudinal equilibrium of the aircraft is therefore written as follows:

$$T * cos ( α ) - D - W * sin ( γ air ) = {a}_{{x}_{w}} * m$$

With:

$$T = f 1 ( N1 , F\_flow , M , {P}_{s} )$$

$$D = q * S * {C}_{x} + Δ {D}_{i c i n g}$$

$${a}_{{x}_{w}} = \frac{{d}_{x} V}{d t} = d ( f ( M , {T}_{s} ) / dx$$

where ΔD_{icing} is the ice-induced drag term, Cₓ is the drag coefficient, q is the dynamic pressure and S is the reference surface.

Isolating the term ΔD_{icing} (which is the one that it is sought to determine, in order to find out the level of ice on the aerofoil) gives the following equation:

$$Δ {D}_{i c i n g} = T * cos ( α ) - m ( g * sin ( γ a i r ) + {a}_{{x}_{w} )} - q * S * {C}_{x}$$

Explaining the dependencies of the various terms (the dynamic pressure q is 0.5*1.4*M²*Pₛ, the drag coefficient Cₓ depends on α, M, Pₛ, POSTHS and the configuration of the aircraft Conf) gives:

$$Δ {D}_{i c i n g} = f 1 ( N 1 , F\_flow , M , {P}_{s} ) * cos ( α ) - m ( g * sin ( γ air ) + {d}_{x} ( f ( M , {T}_{s} ) ) / dt ) - ( 0. 5 * 1.4 * {M}^{2} * {P}_{s} ) * S * f 2 ( α , M , {P}_{s} , Conf , POSTHS )$$

with f1 the actual thrust generated by the aircraft and f2 the actual drag, excluding that induced by ice. These functions are unknown in flight, but depend on parameters that are measured continuously.

Based on the results of this equation, it was possible to define a first batch of relevant parameters at the input of the model: γair, α, M, N1, F_flow, m, POSTHS, Tₛ and Pₛ. As mentioned above, the set of flight parameters may also comprise one or more information redundancy parameters (among Vc and Pt) and/or one or more context parameters (among φ, θ, Ψ, p1, q1, r1, β, Zp, Vz and CG).

In the phase of teaching the model (for example in supervised mode), labelled data, that is to say values of the abovementioned flight parameters at flight times for which the level of ice on the aerofoil is known, are injected into the model. The labelled data form a training, validation and test base for the model. The labelled data are actual flight data, possibly supplemented by simulated flight data obtained with a simulator.

For example, to obtain more training data, a simulator is used to model the behaviour of the aircraft when it is subjected to ice accretion. For example, multiple simulation scenarios are used to represent manoeuvres and situations encountered in the cruise phase as exhaustively as possible. Each scenario consists of one or more manoeuvres ordered to the autopilot of the aircraft. Exemplary scenarios: level flight at a given flight point, level speed change with simulation of occasional gusts of wind and turbulence, climbing with a constant slope with simulation of occasional gusts of wind and turbulence, descending with a constant slope with simulation of occasional gusts of wind and turbulence, climbing at a constant vertical rate, descending at a constant vertical rate, 180° left turn with simulation of occasional gusts of wind and turbulence, 180° right turn with simulation of occasional gusts of wind and turbulence. For each scenario, the parameters recorded over time are for example sampled at 4 Hz. This offers a good compromise between calculation time and faithful monitoring of the temporal evolution of the recorded signals. For example, each of the scenarios is played out at 10000 different flight points, each flight point being distinguished by the value of one of the flight parameters or by the level of ice. Next, the data are formatted, this depending on the developed model.

In one variant, if it is possible to detect turbulence robustly on board the aircraft, it may be appropriate to train the model only on (actual or simulated) flight data without turbulence. Once on board, it will be sufficient to turn off the ice detection as soon as turbulence is detected so as not to take into account false alarms in this scenario.

FIG. 4 schematically illustrates the model used by the system for detecting the presence of ice from FIG. 1, in one embodiment. The model here is a deep neural network, and more specifically a convolutional neural network (CNN) 400 comprising (in order): an input layer 401, a first convolutional layer 402, a first subsampling layer (also called a pooling layer) 403, a second convolutional layer 404, a second subsampling layer 405, a flatten layer 406, a first linear layer 407 and a second linear layer 408.

Each layer plays a particular role:
the convolutional layers 402 and 404 use for example a “ReLu” (rectified linear unit) activation function and transform the current state of the aircraft provided at input (in the form of signals that are the measurements of the set of N_{P} flight parameters discussed above) into N_{P} explanatory parameters (also called “explanatory variables” or features) that encode the information contained in the temporal evolution of the signals. In other words, each of the N flight parameters therefore constitutes one of the N_{P} explanatory parameters;
the subsampling (pooling) layers 403 and 405 make it possible to reduce the size of the neural network (in order to make it easier to embed) and to a certain degree to prevent overfitting, that is to say overlearning of the neural network on the training set, which is responsible for a lack of reliability of predictions made on unknown data;
the linear layers 407 and 408 use for example a “ReLu” activation function and use the encoding of the current state of the aircraft to predict the class of ice at output (five distinct levels of ice to be discriminated between); and
the second linear layer 408 (output layer) uses for example the softmax activation function at the output of the neural network, thereby making it possible to obtain a probability of belonging to each class and making it easier to interpret the results.

One advantage of the convolutional neural network 400 is that it makes it possible to take into account the temporal correlation between the various temporal measurement points. In fact, the pitch angle at t=20 s is strongly correlated with that measured at t=20.25 s, and far less so with that at t=1 s. In order to increase precision in terms of classifying the levels of ice, use is therefore made of a convolutional neural network architecture capable of taking into account this temporal evolution.

The model 400 from FIG. 4 may be embedded because it does not have an excessively large number of layers or layers that are excessively wide. Depending on whether priority is given to performance or ability to be embedded, it is possible to opt for another neural network architecture. For example, adding new convolutional layers and another linear layer at output allows even greater reliability in terms of detecting the level of ice, at the expense of a model that is more difficult to embed on an on-board computer. Conversely, removing a convolutional layer and a subsampling (pooling) layer from the presented architecture reduces performance but makes the solution easier to embed.

In one embodiment, each row of the database used to train the model 400 is a matrix of size 120×21 (21 explanatory parameters (features), each corresponding to a signal of 120 temporal measurement points corresponding to a duration (time window) of 30 s with sampling at 4 Hz).

If the architecture is a neural network, a Min-Max normalization is carried out on each value of the various signals. For each point pk of each signal i associated with an explanatory parameter (feature) j:

$${p}_{k} = \frac{{p}_{k} - min ( j , ∀ i , ∀ k )}{max ( j , ∀ i , ∀ k ) - min ( j , ∀ i , ∀ k )} ∈ [ 0 , 1 ]$$

The training is then carried out on some of the rows of the training base, keeping the rest as a validation set and test set. The cost function selected for the training is for example the cross entropy loss function. This is a conventional loss function in a multi-class classification problem. For a batch of N data during learning, the formula is as follows:

$$L = - \frac{1}{N} {\sum }_{i = 1}^{N} {\sum }_{j = 1}^{C} {y}_{i j} log ( {p}_{i j} )$$

With:
N the number of samples in the batch;
C the number of classes (here 5);
yᵢⱼ=1 if the datum is associated with the class j, 0 otherwise; and
pᵢⱼ the predicted probability of the datum i belonging to the class j.

It is also possible to use a variant of the cross entropy loss cost function when training the model. For example, if using log-probabilities, for a datum n of a batch of N data during learning, the formula for this cost function is as follows:

$${l}_{n} = - {\sum }_{c = 1}^{C} {w}_{c} log ( \frac{exp ( {x}_{n , c} )}{{\sum }_{i = 1}^{C} exp ( {x}_{n , i} )} ) {y}_{n , c}$$

With:
C the number of classes (here 5);
w_{c} a manual weight to be assigned to each class in case of inconsistent data;
x_{n,i} the predicted probability of the datum n being of the class i; and
y_{n,c}=1 if the datum n is actually of the class c, 0 otherwise.

Once the model has been trained and then validated, it may be used on board to detect the level of ice on the aerofoil in real time. It should be noted that the neural network in the embodiment presented above is said to be “fixed” because its coefficients are constant, once they have been calculated offline. There is no online adaptation (that is to say no updating of the coefficients), so the solution remains deterministic.

If, for the training phase, the actual flight data are supplemented with simulated flight data, it is possible to improve the realism of the simulations.

Indeed, if the flight points are generated by randomly drawing the parameters that characterize the model (altitude, initial speed, heading, etc.) and if each parameter is drawn well between two bounds corresponding to operational limits, certain flight points that are ultimately generated may be located outside the flight domain, or even be physically impossible. For example, it is possible to generate a flight point where the aircraft has a low mass and moves slowly at high altitude, and this is then at the stall limit, outside the flight domain, and a datum that is not useful for training the model is obtained. To overcome this problem, charts available in the technical documentation of a typical aircraft have been numerically coded in order to take into account interdependencies between certain parameters associated with flight points (for example centring, mass, pressure altitude, Mach). By using double interpolations and by numerically calculating, for example using an SVM (support vector machine) algorithm, the equation for the boundary between valid and invalid pairs of parameters (for example mass/Mach), it is possible to generate only valid flight points to carry out the model simulations. This has three main advantages: because abnormal behaviour is eliminated during simulations, all simulations carried out are valid and may be used to build the training and validation set; the calculation on the simulator is faster because the aircraft balancing phase is carried out very quickly, since no selected flight point is associated with extreme conditions; more data are obtained at the end of each simulation series since no flight point is rejected by the simulator.

It is also possible to improve the realism of the signals obtained by simulations, by adding a bias to the various sensors a posteriori, in order to reflect the actual biases of the sensors on the aircraft (which differ depending on the aircraft). A random bias is therefore drawn within the bounds defined by the technical specifications of the various sensors. For example, a few typical biases are as follows: pressure altitude of 100 ft, Mach of 0.02, static temperature of 2° C., N1 of 2%, mass of 5 T, etc.

It is also possible to add measurement noise to the recorded signals. This brings the signals used during training even closer to the actual signals, so that the good performance of the model on the simulated data is able to be transferred more easily to the real data.

It is also possible to improve the robustness of the model by increasing the variability of the simulated data. For this purpose, the time windows, for example of 30 seconds (containing 120 temporal measurement points obtained with sampling at 4 Hz), are not successive, but are placed randomly along the simulation (and without any overlap), thereby making it possible to take a smaller number thereof.

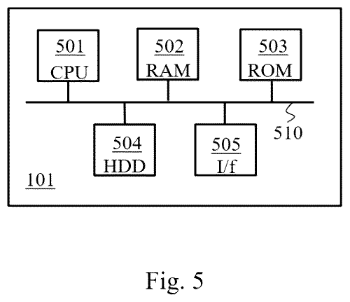

FIG. 5 schematically illustrates an exemplary hardware architecture of the system 101 for detecting the presence of ice, which then comprises the following, connected by a communication bus 510: a processor or CPU (central processing unit) 501; a random access memory (RAM) 502; a read-only memory (ROM) 503, for example a flash memory; a data storage device, such as a hard disk drive (HDD), or a storage medium reader, such as a Secure Digital (SD) card reader 504; at least one communication interface 505 enabling the system 101 for detecting the presence of ice to interact with one or more items of equipment of the aircraft 100, and more particularly avionics equipment of the aircraft 100.

The processor 501 is capable of executing instructions loaded into the random access memory RAM 502 from the read-only memory ROM 303, from an external memory (not shown), from a storage medium, such as an SD card, or from a communication network (not shown). When the system 101 for detecting the presence of ice is turned on, the processor 501 is capable of reading instructions from the random access memory RAM 302 and of executing them. These instructions form a computer program that causes the processor 501 to implement the behaviours, steps and algorithm described here.

All or some of the behaviours, steps and algorithm described here may thus be implemented in software form by executing a set of instructions using a programmable machine, such as a digital signal processor (DSP) or a microcontroller, or be implemented in hardware form by a machine or a dedicated component (chip) or a dedicated set of components (chipset), such as a field-programmable gate array (FPGA) or an application-specific integrated circuit (ASIC). Generally speaking, the system 101 for detecting the presence of ice comprises electronic circuitry designed and configured to implement the behaviours, steps and algorithms described here.

1. A method for detecting the presence of ice on an aircraft, the method being implemented by a detection system comprising electronic circuitry, the method comprising:
obtaining, in real time, measurements of a set of flight parameters of the aircraft, the measurements being provided by sensors present in the aircraft, the set of flight parameters comprising a batch of nine flight parameters comprising: a slope, denoted γair; an incidence, denoted α; a Mach number, denoted M; a rotational speed of a low-pressure propulsion engine assembly of the aircraft, denoted N1; a fuel flow, denoted F_flow; a mass of the aircraft, denoted m; a position of a trimmable horizontal stabilizer, denoted POSTHS; a static temperature, denoted Ts; and a static pressure, denoted Ps;
injecting the obtained measurements into an artificial-intelligence machine learning-based model, trained and configured to calculate an indicator of the presence of ice on the aircraft based on measurements of the set of flight parameters of the aircraft; and
providing the presence of ice indicator calculated by the machine learning-based model;
the nine flight parameters of said batch being chosen for their presence in a first equation expressing an ice-induced drag, denoted ΔD_{icing}, and written:
$$Δ {D}_{i c i n g} = f 1 ( N 1 , F\_flow , M , {P}_{s} ) * cos ( α ) - m ( g * sin ( γ air ) + {d}_{x} ( f ( M , {T}_{s} ) ) / dt ) - ( 0. 5 * 1.4 * {M}^{2} * {P}_{s} ) * S * f 2 ( α , M , {P}_{s} , Conf , POSTHS )$$
said first equation deriving from a second equation expressing a longitudinal equilibrium of the aircraft and being written:
$$T * cos ( α ) - D - W * sin ( γ air ) = {a}_{{x}_{w}} * m$$
where:
T is a thrust of the aircraft, with: T=f1(N1, F_flow, M, Pₛ), where f1 is an actual thrust generated by the aircraft,
D is a drag of the aircraft, with: D=q*S*Cₓ+ΔD_{icing}, where S is a reference surface, Cₓ is a drag coefficient, with Cₓ=f2(α, M, Pₛ, Conf, POSTHS), where f2 is an actual drag, excluding that induced by ice, Conf is a configuration of the aircraft, and q is a dynamic pressure, with: q=0.5*1.4*M²*Pₛ,
W is a weight of the aircraft, with: W=m*g, where g is a gravitational acceleration,
and aₓ_{_{w}} is an acceleration of the aircraft, with: aₓ_{_{w}}=dₓV/dt=dₓ(f(M,Tₛ))/dt, where f expresses a speed V of the aircraft as a function of M and Tₛ.

2. The method according to claim 1, wherein the set of flight parameters of the aircraft furthermore comprises at least one information redundancy parameter belonging to the group comprising: a true speed, denoted Vc; and a total pressure, denoted Pt.

3. The method according to claim 1, wherein the set of flight parameters of the aircraft furthermore comprises at least one context parameter belonging to the group comprising: a roll angle, denoted φ; a pitch angle, denoted θ; a yaw angle, denoted Ψ; a roll rate, denoted p1; a pitch rate, denoted q1; a yaw rate, denoted r1; a slip angle, denoted β; a pressure altitude, denoted Zp; a vertical speed, denoted Vz; and centring information, denoted CG.

4. The method according to claim 1, wherein the machine learning-based model is a deep neural network.

5. The method according to claim 4, wherein the deep neural network is a convolutional neural network comprising at least one convolutional layer and at least one subsampling layer.

6. (canceled)

7. A non-transitory storage medium storing a computer program comprising instructions that cause a processor to carry out the method according to claim 1 when said instructions are read and executed by the processor.

8. A system for detecting the presence of ice on an aircraft, the system comprising electronic circuitry configured to implement the following:
obtaining, in real time, measurements of a set of flight parameters of the aircraft, the measurements being provided by sensors present in the aircraft, the set of flight parameters comprising a batch of nine flight parameters comprising: a slope, denoted γair; an incidence, denoted α; a Mach number, denoted M; a rotational speed of a low-pressure propulsion engine assembly of the aircraft, denoted N1; a fuel flow, denoted F_flow; a mass of the aircraft, denoted m; a position of a trimmable horizontal stabilizer, denoted POSTHS; a static temperature, denoted Tₛ; and a static pressure, denoted Pₛ;
injecting the obtained measurements into an artificial-intelligence machine learning-based model, trained and configured to calculate an indicator of the presence of ice on the aircraft based on measurements of the set of flight parameters of the aircraft; and
providing the presence of ice indicator calculated by the machine learning-based model;
the nine flight parameters of said batch being chosen for their presence in a first equation expressing an ice-induced drag, denoted ΔD_{icing}, and written:
$$Δ {D}_{i c i n g} = f 1 ( N 1 , F\_flow , M , {P}_{s} ) * cos ( α ) - m ( g * sin ( γ air ) + {d}_{x} ( f ( M , {T}_{s} ) ) / dt ) - ( 0. 5 * 1.4 * {M}^{2} * {P}_{s} ) * S * f 2 ( α , M , {P}_{s} , Conf , POSTHS )$$
said first equation deriving from a second equation expressing a longitudinal equilibrium of the aircraft and being written:
$$T * cos ( α ) - D - W * sin ( γ air ) = {a}_{{x}_{w}} * m$$
where:
T is a thrust of the aircraft, with: T=f1(N1, F_flow, M, Pₛ), where f1 is an actual thrust generated by the aircraft,
D is a drag of the aircraft, with: D=q*S*Cₓ+ΔD_{icing}, where S is a reference surface, Cₓ is a drag coefficient, with Cₓ=f2(α, M, Pₛ, Conf, POSTHS), where f2 is an actual drag, excluding that induced by ice, Conf is a configuration of the aircraft, and q is a dynamic pressure, with: q=0.5*1.4*M²*Pₛ,
W is a weight of the aircraft, with: W=m*g, where g is a gravitational acceleration,
and aₓ_{_{w}} is an acceleration of the aircraft, with: aₓ_{_{w}}=dₓV/dt=dₓ(f(M,Tₛ)/dt, where f expresses a speed V of the aircraft as a function of M and Tₛ.

9. An aircraft comprising the system for detecting the presence of ice according to claim 8.
